(19) United States
(12) Patent Application Publication
(10) Pub. No.: US 2020/0012802 A1
(43) Pub. Date: Jan. 9, 2020

(54) FILE SYSTEM LOCK DOWN

(71) Applicant: HEWLETT PACKARD ENTERPRISE DEVELOPMENT LP, Houston, TX (US)

(72) Inventor: Rajkumar Kannan, Bangalore (IN)

(21) Appl. No.: 16/027,553

(22) Filed: Jul. 5, 2018

(51) Int. Cl. G06F 21/62; G06F 21/60; G06F 17/30

(52) U.S. Cl. CPC G06F 21/62; G06F 17/30171; G06F 21/604

(57) ABSTRACT

Example implementations relate to a file system lock down. In an example, an audit log is produced from I/O events related to data placed on a storage medium and managed by a file system. The audit log is analyzed based on compliance policies to generate a control signal. A compliance enforcer integrated in an I/O path of the file system sends a file system lock down command directly to the file system in response to the control signal indicating that a compliance policy has been violated by at least one of the I/O events in the audit log.

### BACKGROUND

A data center may include storage systems. Client devices may communicate with the storage systems over network connections. Users of client devices may attempt to access file system objects stored on the storage systems.

### BRIEF DESCRIPTION OF THE DRAWINGS

Various examples will be described below with reference to the following figures.

FIG. 1 is a diagram depicting an example system that can execute a file system lock down based on file access auditing.

FIG. 2 is a block diagram of an example that includes a non-transitory, machine readable medium encoded with instructions for file system auditing and lock down.

FIG. 3 is a flow diagram depicting an example method for executing a file system lock down.

FIG. 4 is a flow diagram depicting an example method for managing file system lock down.

FIG. 5 is a flow diagram depicting an example method for processing events in an audit log.

FIG. 6 is a flow diagram depicting an example method for managing lock down statistics.

Throughout the drawings, identical reference numbers may designate similar, but not necessarily identical, elements.

### DETAILED DESCRIPTION

Storage systems form part of data center infrastructure. Storage systems may store data and allow client devices, such as servers, workstations, desktop computers, to access the data. For example, a storage system may have storage resources, such as hard disk drives, solid state drives, etc. Management and control features of the storage system may implement a logical arrangement to store data on the storage resources. For example, a logical arrangement may include components such as a file system, a virtual file server, a file store, and a file share, and these components may be organized in a directory hierarchy. Client devices may interface with and access (e.g., read, write, or delete) data stored in a file system over any wired and/or wireless network (e.g., Ethernet, optical fiber, Wi-Fi®, etc.) and via protocols such as SMB (Server Message Block) and NFS (Network File System).

An organization may utilize a file system to retain data for various reasons, such as business or regulatory reasons. For example, organizations may retain data for a retention period that may be defined by statute or any other policy or regulation. Some file systems may allow file shares to be marked for compliance and/or with degrees of importance, and marked file shares may be tracked for auditing.

However, security risks to data retained in file systems may include information theft, misuse of data, destruction of confidential or sensitive data, and the like, and such risks may come from actors external to the organization as well as actors inside the organization. For example, administrators and power/privileged users may pose a high risk of insider threats.

Some file systems may detect and/or protect against external threats but not internal threats. Some approaches to safeguarding file systems may utilize an independent software vendor (ISV) application to pull and analyze audit logs of the file system and raise alerts when threats are detected, but such approaches are outside of the file system and substantial theft or loss of data may have already occurred by the time the organization is alerted. Moreover, utilizing an ISV application may be financially expensive.

Thus, it may be useful to provide for file system auditing and compliance enforcement that is tightly integrated to the file system. Examples described herein may relate to auditing events from file protocol clients, analyzing an audit log of events based on compliance policies, and, in response to detecting that an event or set of events violate at least one compliance policy, cause the file system to execute a lock down of the file system via a compliance enforcer integrated in an I/O (input/output) path of the file system. By virtue of being integrated in the file system I/O path, the compliance enforcer can proactively track suspect activity and autonomously prevent damage to data earlier and with reduced latency compared to other approaches, such as ISV applications. Such tightly integrated lock down and early prevention also may provide a useful time window for a system administrator to review suspicious activity and to intervene in false positive cases.

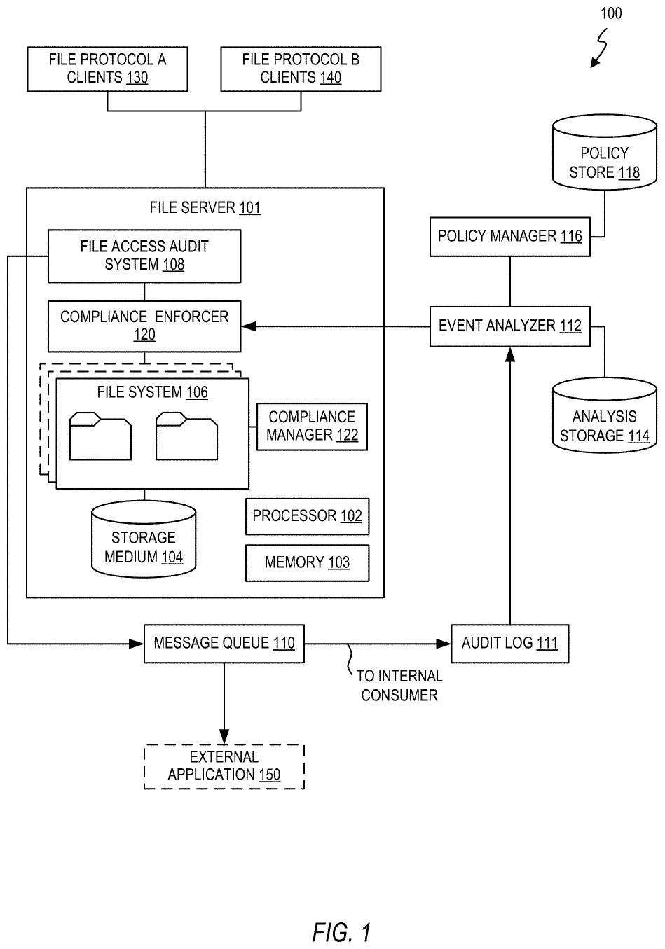

Referring now to the figures, FIG. 1 is a block diagram depicting an example environment 100 that includes a file server 101. The file server 101 may be a hardware device that includes a processor 102, a memory 103, and a storage medium 104. Examples of the processor 102 may include microprocessors, microcontrollers, central processing units, application-specific integrated circuits (ASICs), field programmable gate arrays (FPGAs), etc. Examples of the memory 103 may include random access memory (RAM), read-only memory (ROM), electrically erasable programmable read-only memory (EEPROM), flash memory, and other volatile or non-volatile media. The memory 103 is “non-transitory” in that the memory 103 does not encompass transitory propagating signals.

The memory 103 may be communicatively coupled to the processor 102 and may store instructions that, when executed by the processor 102, cause the processor 102 to perform functions described herein. For example, a file access audit system 108, a compliance enforcer 120, and a compliance manager 122 may be implemented by processor executable instructions stored in the memory 103. In some implementations, an event analyzer 112 and a policy manager 116 may also be implemented by processor executable instructions stored in the memory 103. In some implementations, one or more components, such as file access audit system 108, message queue 110 and audit log 111, event analyzer 112, analysis store 114, policy manager 116, policy store 118, may be implemented outside of file server 101, such as on a remote server or among multiple servers in a distributed computing arrangement.

Examples of the storage medium 104 may include hard disk drives, solid state drives, or the like, or a plurality of such storage devices (e.g., an array of disks). The storage medium 104 is the physical medium on which data is stored. The file server 101 may include a file system 106 that manages the data placed on the storage medium 104. For example, the file system 106 may logically organize and present the data stored on the storage medium 104 as individual files, a file share (e.g., folder of files), or other levels of granularity. In some implementations, the file system 106 may run in kernel mode of the file server 101. Other implementations of the file system 106 may run at least in part in user mode of the file server 101.

The file system 106 also services I/O events from file protocol clients directed to files, file shares, etc., such as read, write, delete, or security (e.g., permissions) change events. For example, FIG. 1 illustrates example file protocol A clients 130 and file protocol B clients 140 (collectively clients 130, 140). File protocol A clients 130 may be one or more client devices that communicate with the file server 101 via NFS protocol. File protocol B clients 140 may be one or more client devices that communicate with the file server 101 via SMB protocol. Other protocols may also communicate with the file server 101. The clients 130, 140 may be servers, desktop computers, workstations, etc. The file system 106 may carry out the I/O events and read data back to the client, write data from the client, or delete data specified by the client.

In some examples, a file server 101 may include a plurality of file systems 106 (indicated by dashed lines in FIG. 1), which may also be referred to as multiple namespaces of the file server 101. In some examples, different file systems 106 may be associated with different tenants of the file server 101.

The file server 101 also includes a file access audit system 108. As I/O events are received by the file system 108 from the clients 130 or 140, the file access audit system 108 produces an audit log 111 of the I/O events from the file system 106. The file access audit system 108 may run in user mode of the file server 101, for example.

In an implementation, the file access audit system 108 produces the audit log 111 by first serializing the structure of the I/O events and publishing the events to a message queue 110. In an example, the message queue 110 may include separate and parallel queues for each protocol (e.g., NFS, SMB). In cases where there are multiple file systems 106 on the file server 101, the file access audit system 108 may serialize I/O events from all of the multiple file systems 106 into the message queue 110. Serialization may be useful for transport of the message queue 110 over a network.

The I/O events may be published to the message queue 110 by the file access audit system 108 with information about or associated with the I/O events. For example, an I/O event in the message queue 110 may include information such as a UID (unique identifier, associated with a user), a GID (group identifier, identifying a group), path information (e.g., file system, file share, directory information, etc.), object information identifying a specific file being accessed, a time stamp, a client IP address, a protocol type, and the like. I/O events related to changes in security settings may include Access Control Entries, indications of success or failure of the security setting operation, etc. I/O events related to reading or writing data may include information about how many blocks of data are read or written.

In some implementations, an external application 150 (i.e., an ISV application) may pull I/O events from the message queue 110. The external application 150 may be deemed outside of the environment 100. A specification for interfacing with the message queue 110 may be referenced for designing the external application 150 to pull and process the serialized I/O events.

Within the environment 100, the file access audit system 108 may further read I/O events out of the queue, deserialize the I/O events, and write the I/O events to an audit log 111. The audit log 111 may include a mix of I/O events associated with different file protocols (e.g., NFS, SMB, etc.). The audit log 111 may be exported to JSON or XML formats or the like. The audit log 111 may be reviewed by users of the file server 101.

The audit log 111 may be consumed by the event analyzer 112, which analyzes the audit log 111 based on compliance policies (also referred to herein as “policies”) provided by the policy manager 116. Alternatively, the event analyzer 112 may consume I/O events directly from the message log 110 in some implementations. Before describing the event analyzer 112 further, the policy manager 116, the policy store 118, and example policies will first be discussed.

The compliance policies may be stored in policy store 118 and managed by the policy manager 116. The policies may describe I/O event activity that triggers a partial or full lock down of the file system 106, and may also describe a file system lock down action to be triggered. In an implementation, the policy store 118 may be a key-value store, key-value database, or the like. The policy store 118 may be included in the file server 101, may be stored in the storage medium 104 or memory 103, or may be stored in a remote server or remote servers. The policy manager 116 may receive a new policy to be added to the policy store 118. The compliance policies may be in a descriptive language that can be visually generated. Policies may be created by a user, via a graphical user interface driven tool for building descriptive and complex rules. Additionally or alternatively, policies may be created by machine learning, or by other like techniques. For example, machine learning or other analytical techniques may model I/O events to determine typical baseline behavior for a user or group of users and generate a policy to detect anomalous or outlier behavior among I/O events.

Some non-limiting examples of policies include the following. Such policies may be useful for detecting insider threats. Example policies may be indexed into the key-value database on a user (e.g., UID) or on a group (e.g., GID). In other words, some policies may be on a per-user or per-group basis. For example, a policy indexed on a user of an I/O event may be “IF user is not owner of target file share AND user has performed N-number of successive deletes (e.g., N=20); THEN disable delete for target file share for user”. Another example policy may be “IF user is not owner of target file share AND target file share is marked as a compliance share with high importance; THEN disable read for target file share for user” (disabling read may also disable some or all other I/O operations).

The foregoing example policies may also be modified for enforcement against a group. In some examples, a particular UID or GID may be associated with one or more policies. Additionally, other policies based on other I/O event characteristics, such as those event information described above as being published in the message queue 110, are also contemplated. Variations in triggered file system lock down action are also contemplated, such as variations in specifying prohibited I/O events more broadly or more narrowly (e.g., one vs. all commands prohibited), specifying different threat actors (e.g., user vs. group, etc.), or specifying different levels of file system object to be protected (e.g., individual files vs. file shares, etc.).

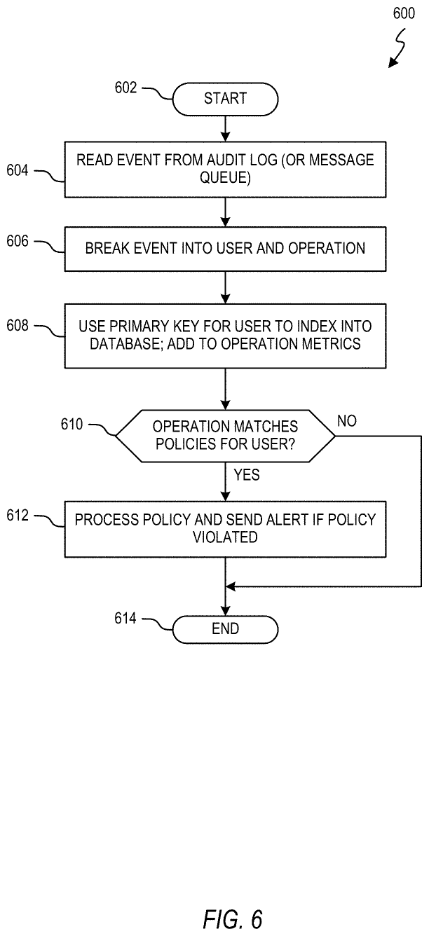

As described above, the event analyzer 112 analyzes I/O events from the audit log 111 against compliance policies stored in the policy store 118 and provided by the policy manager 116. In an implementation, the event analyzer 112 may pass UIDs or GIDs of I/O events to the policy manager 116, which in turn uses the UIDs or GIDs as indices into the policy store 118 to identify one or more relevant policies. The event analyzer 112 may then determine whether I/O events in the audit log 111 violate the identified policies. Some policies may be evaluated over a period of time or, in other words, may be evaluating I/O events cumulatively over time, as will also be described below with respect to FIG. 6 (e.g., similar to the “N-number of successive delete events” policy described above). The analysis storage 114 may be used as a staging area to store intermediate or ongoing results of analysis of such policies. The analysis storage 114 also may be used to archive results of completed policy analyses, which may be used later for forensics, compliance audits, or the like. The analysis storage 114 may be included in the file server 101, may be part of the storage medium 104 or memory 103, or may be implemented in a remote server or remote servers.

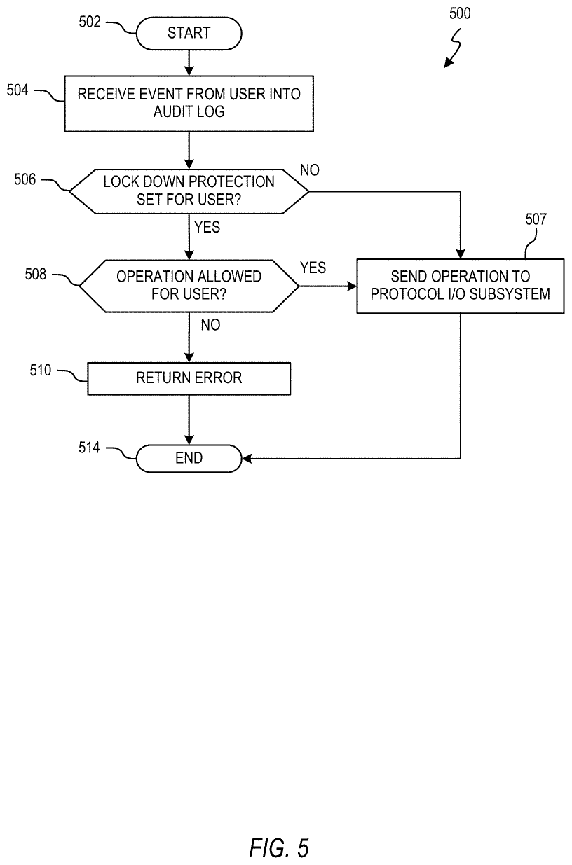

If an I/O event does not violate any relevant policies, the I/O event may be released to be serviced by the file system 106. If an I/O event violates a relevant policy, the event analyzer 112 generates a control signal that is transmitted to the compliance enforcer 120. The control signal is indicative of at least one policy of the compliance policies having been violated by at least one of the I/O events in the audit log 111. The control signal instructs the compliance enforcer 120 to perform a file system lock down action. In some implementations, the control signal may include a particular file system lock down action to be taken, such as an action predefined for the violated policy, and may be specific to any of prohibited I/O event type(s), actor(s) (user or group), or file system object(s) to enforce. For example, a predefined action may be an example action illustrated above with respect to the description of the policy manager 116 and policy store 118 (e.g., such as disabling deletes for the targeted file share for the user). Additional examples of processes executed by the event analyzer 112 to analyze I/O events will be described below with respect to FIGS. 5 and 6.

The compliance enforcer 120 is integrated in an I/O path of the file system 106. That is, the I/O events from clients 130 and 140 pass through the compliance enforcer 120 to be serviced by the file system 106. Even in implementations where some components (e.g., file access audit system 108, event analyzer 112, and/or policy manager 116) are implemented outside of the file server 101, the compliance enforcer 120 is integrated with the file system 106 within file server 101. In implementations where the file system 106 runs in kernel mode and the file access audit system 108 and event analyzer 112 run in user mode, the compliance enforcer 120 may be a user-kernel mode bridge between the user mode file access audit system 108 and the kernel mode file system 106. To minimize latency in the I/O path, in some implementations, the more computationally intensive event analysis is offloaded to the event analyzer 112 and the compliance enforcer 120 is designed as a lightweight logic that gates I/O events based on control signals from the event analyzer 112.

By virtue of such tight integration, the compliance enforcer 120 can communicate the lock down enforcement intent resulting from event analysis to the file system 106 and mitigate data loss and destruction from insider threats in a timely manner. The event analyzer 112 analyzes the audit log 111 and the compliance enforcer 120 causes the file system to execute file system lock downs in real-time, as I/O events are received at the file system 106 from file protocol clients 130, 140.

Responsive to a control signal from the event analyzer 112, the compliance enforcer 120 causes the file system 106 to execute a file system lock down. In some implementations, the compliance enforcer 120 may send a command instructing the file system 106 to fail I/O events associated with the user (or group) and/or file share (or file within a file share) that triggered the control signal at the event analyzer 112. In some implementations, the compliance enforcer 120 may send the command on the I/O path to the file system 106. In enforcing the lock down, the file system 106 may return error codes (e.g., standard POSIX errors such as read-only, file system inaccessible, or file system unmounted) to clients 130, 140 when failing I/O events. In cases where the file server 101 hosts multiple file systems 106 (namespaces), e.g. for multiple tenants, the compliance enforcer 120 can communicate with all the file systems 106 on the file server 101 and executes a file system lock down against a particular file system of the multiple file systems as instructed by the control signal (e.g., the control signal may indicate a particular file share to lock down, and thus also indicate a particular file system implicitly or explicitly).

In some implementations, a file system lock down triggered for one file server 101 may be communicated and distributed to other file servers within a data center or across multiple data centers. For example, a suspect user may be denied access to all file shares across all of an organization's data center(s). As another example, a group of users may be denied write access to compliance-marked file shares across all of an organization's data center(s). In this manner, protection against insider threats may be extended across an entire organization.

In some implementations, the file system 106 and/or the compliance enforcer 120 may also report the file system lock down via a compliance manager 122 to an administrator or compliance officer, particularly if the lock down is enforced against a compliance-marked file share. The compliance manager 122 may be in communication with the file system 106 and provide for re-enabling a file share (or file) that is disabled by a file system lock down action. For example, the compliance manager 122 may present a two-person authorization security control via a user interface or web portal for both a compliance officer and a system administrator (or other similarly responsible and authorized parties as configured for a regulated file system) to review the lock down situation and approve a file share re-enablement. Using a multi-person authorization may further reduce the occurrences of malicious insider threat. Alternatively or additionally, a file system lock down may be relaxed after a timeout period or the file system lock down action may be specified in the policy as lasting a certain amount of time.

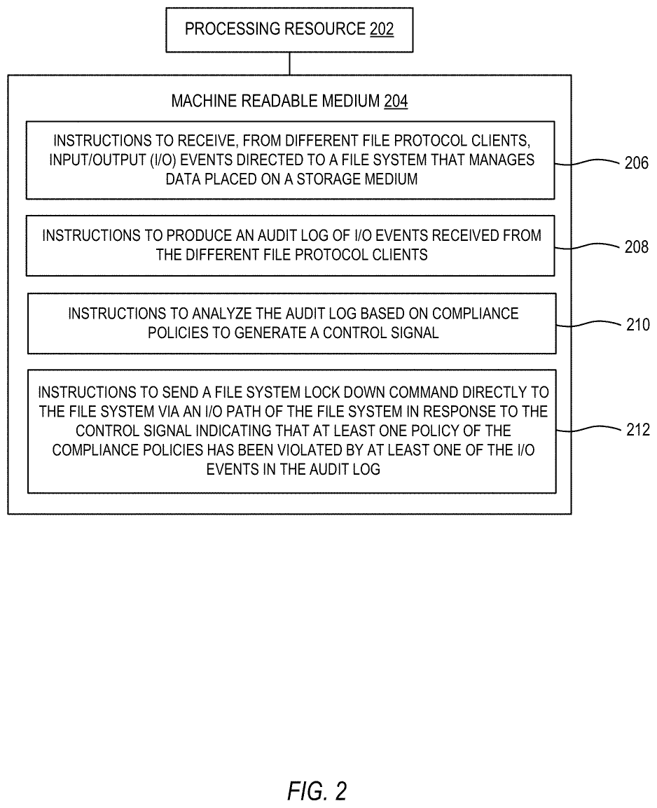

FIG. 2 is a block diagram of an example that includes a processing resource 202 coupled to a non-transitory, machine readable medium 204 encoded with example instructions. The processing resource 202 may include a microcontroller, a microprocessor, central processing unit core(s), an ASIC, an FPGA, and/or other hardware device suitable for retrieval and/or execution of instructions from the machine readable medium 204 to perform functions related to various examples. Additionally or alternatively, the processing resource 202 may include electronic circuitry for performing the functionality of the instructions described herein. The processing resource 202 may serve as or be analogous to the processor 102 of the file server 101, and the non-transitory machine readable medium 204 may serve as or be analogous to the memory 103 of the file server 101.

The machine readable medium 204 may be any medium suitable for storing executable instructions, such as RAM, ROM, EEPROM, flash memory, a hard disk drive, an optical disc, or the like. The machine readable medium 204 may be disposed within a system (such as file server 101), in which case the executable instructions may be deemed “installed” or “embedded” on the system. Alternatively, the machine readable medium 204 may be a portable (e.g., external) storage medium, and may be part of an “installation package.”

As described further herein below, the machine readable medium 204 may be encoded with a set of executable instructions 206, 208, 210, 212. It should be understood that part or all of the executable instructions and/or electronic circuits included within one box may, in alternate implementations, be included in a different box shown in the figures or in a different box not shown. The instructions 206-212 may be useful for implementing aspects of the file access audit system 108, the event analyzer 112, or the compliance enforcer 120 described above.

Instructions 206, upon execution, cause the processing resource 202 to receive, from different file protocol clients 130, 140, I/O events directed to a file system 106 that manages data placed on a storage medium 104. Instructions 208, upon execution, cause the processing resource 202 to produce an audit log 111 of I/O events received from the different file protocol clients 130, 140. In some implementations, instructions 208 may be useful for implementing aspects of the file access audit system 108 described above. In some cases, the file system 106 described with respect to instructions 206 may be among a plurality of file systems on a same file server 101, and instructions 208 may produce the audit log 111 by serializing all I/O events directed to the plurality of file systems.

Instructions 210, when executed, cause the processing resource 202 to analyze the audit log 111 based on compliance policies to generate a control signal. The control signal may indicate that at least one policy of the compliance policies has been violated by at least one of the I/O events in the audit log 111. For example, instructions 210 may use compliance policies provided in a policy store 118 as described above, such as per-user or per-group policies. To analyze the audit log 111, instructions 210 may cause the processing resource 202 to break down each of the I/O events in the audit log 111 into a user (e.g., UID) and an operation (e.g., read, write, delete, etc.) and assess whether the user and/or the operation violate any of the compliance policies. In some implementations, instructions 210 may be useful for implementing aspects of the event analyzer 112 described above.

Instructions 212, when executed, cause the processing resource 202 to send a file system lock down command directly to the file system via an I/O path of the file system 106 in response to the control signal of instructions 210. The lock down command may cause the file system 106 to fail I/O events for a specific file share per the control signal, that is, for a file share for which a policy violation was detected by instructions 210. In some implementations, instructions 212 may be useful for implementing aspects of the compliance enforcer 120 described above. Where the file system 106 is among a plurality of file systems, the file system lock down command is directed at a specific file system that is associated with the control signal, and thus associated with a policy violation.

In some implementations, the machine readable medium 204 may include additional instructions. For example, the machine readable medium 204 may include instructions to present a two-person authorization security control to re-enable a file share disabled by the file system lock down. The machine readable medium 204 also may include instructions to communicate to other file systems in an organization's data center(s) that a file system lock down has occurred with respect to a particular user, group, file, file share, etc. For example, a file system lock down message that is or is based on the control signal may be communicated to the other file systems.

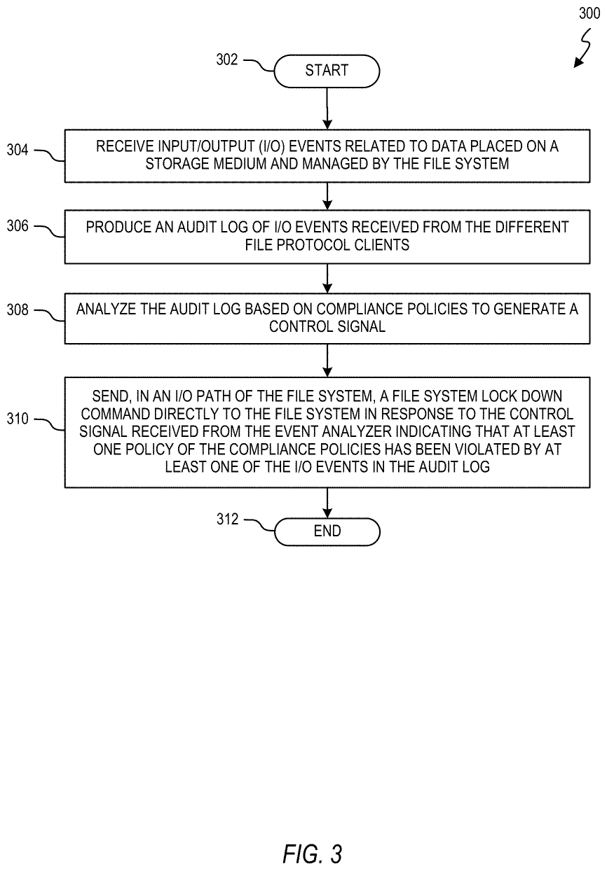

FIGS. 3-6 are flow diagrams depicting various example methods. In some implementations, one or more blocks of a method may be executed substantially concurrently or in a different order than shown. In some implementations, a method may include more or fewer blocks than are shown. In some implementations, one or more of the blocks of a method may, at certain times, be ongoing and/or may repeat. The methods may be implemented in the form of executable instructions stored on a machine readable medium (e.g., such as memory 103) and executed by a processing resource (e.g., such as processor 102) and/or in the form of electronic circuitry. In some examples, various components of environment 100 or instructions of the machine readable medium 204 may be useful for performing the methods.

FIG. 3 is a flow diagram depicting an example method 300 for executing a file system lock down. Method 300 begins at block 302 and continues to block 304, where a file system 106 receives from different file protocol clients 130, 140 I/O events related to data placed on a storage medium 104 and managed by the file system 106.

At block 306, a file access audit system 108 produces an audit log 111 of I/O events received by the file system 106 from the different file protocol clients 130, 140. Block 306 may include additional actions for producing the audit log 111, as described above with respect to the file access audit system 108, such as serializing I/O events from the file system(s) into message queue 110.

At block 308, an event analyzer 112 analyzes the audit log 111 based on compliance policies to generate a control signal. The control signal may indicate that at least one policy of the compliance policies has been violated by at least one of the I/O events in the audit log.

At block 310, a compliance enforcer 120 integrated in an I/O path of the file system 106 sends a file system lock down command directly to the file system 106 in response to the control signal generated at block 308 and received from the event analyzer. For example, the file system lock down command may cause the file system 106 to fail I/O events for a specific file share associated with the control signal, that is, for a file share for which a policy was violated. Where multiple file systems exist on a file server, the file system lock down command is sent to a particular file system that is associated with the control signal.

In some implementations, after a file share is locked down and disabled at block 310, the method 300 may also include presenting (not shown), by a compliance manager 122 in communication with the file system 106, a two-person authorization security control to re-enable the disabled file share. At block 312, the method 300 ends.

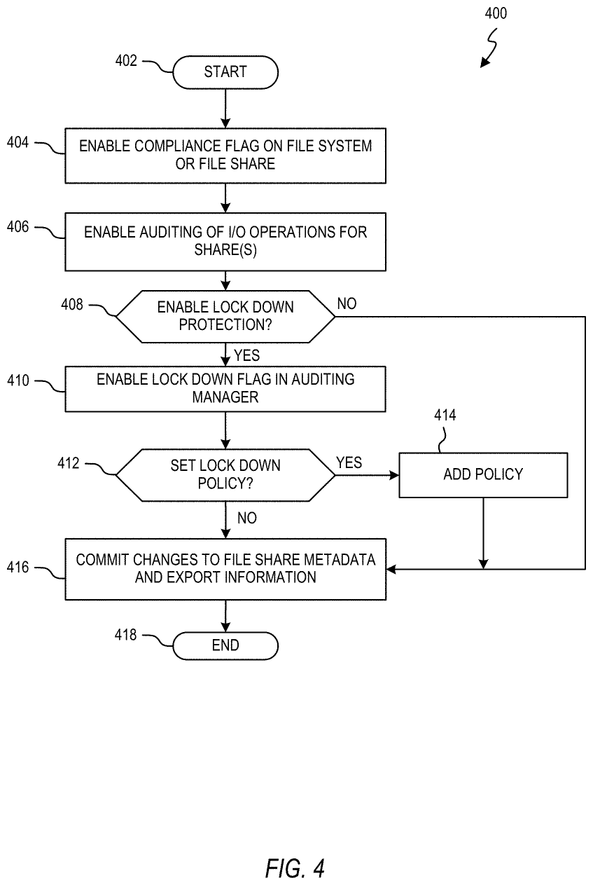

FIG. 4 is a flow diagram depicting an example method 400 for managing or administrating a file system lock down feature. The method 400 starts at block 402 and continues to block 404, where a compliance flag is enabled on the file system 106 or a file share of the file system 106. By marking the file system with a compliance flag, auditing of the file system or file share may be enabled at block 406.

At block 408, a check is made for whether lock down protection is enabled. If lock down protection is not enabled (“NO” at block 408), method 400 proceeds to block 416, where audit enabled status and lock down disabled status are committed to file share metadata and information is exported to the registry. If lock down protection is enabled (“YES” at block 408), a lock down enabled flag is set in an auditing manager at block 410.

After block 410, block 412 determines whether a lock down policy is to be set (i.e., created or modified). If a policy is to be set, the policy provider 116 receives a policy into the policy store 118 at block 414. For example, a policy may be created by a user and/or by machine learning. The policy store 118 may maintain policies in a key-value store. After blocks 412 or 414, the audit enabled and lock down enabled states are committed to file share metadata at block 416. Method 400 ends at block 418.

FIG. 5 is a flow diagram depicting an example method 500 for processing events in an audit log. Some aspects of method 500 may be useful for implementing aspects of event analyzer 112 or block 308 of method 300.

Method 500 begins at block 502 and continues to block 504, where the file system 106 receives an event into the audit log 111. The event is associated with a user (UID). At block 506, the event analyzer 112 determines whether lock down protection was set for the user. If lock down protection was not set (“NO” at block 506), control passes to block 507 where the operation is permitted to pass (e.g., by the compliance enforcer 120) to the protocol I/O subsystem of file system 106 for servicing.

If lock down protection is set (“YES” at block 506), control passes to block 508, where the event analyzer 112 determines whether the operation of the event is allowed for the user. If the operation is allowed (“YES” at block 508), control passes to block 507 as described above. If the operation is not allowed (“NO” at block 508), control passes to block 510, where the compliance enforcer 120 blocks the I/O and causes an error to be returned to the user client. Method 500 ends at block 514.

FIG. 6 is a flow diagram depicting an example method 600 for managing lock down statistics. Method 600 may be useful for implementing aspects of event analyzer 112 and block 308 of method 300, such as for analyzing policies over a period of time.

Method 600 begins at block 602 and continues to block 604, where the event analyzer 112 reads an I/O event from the audit log 111. In some implementations, the event analyzer 112 may read an I/O event from the message queue 110 directly. At block 606, the event analyzer 112 may break or parse the read I/O event into a user (UID) and an operation. In other implementations, block 606 may involve breaking the I/O event into other pieces of information, such as a group (GID), a client IP address, a protocol type, a timestamp, path information, file object information, etc. The information extracted from the I/O event may be configured depending on the type of threats to be monitored.

At block 608, the event analyzer 112 uses a primary key for the user (e.g., UID) to index into the policy store 118 database via the policy manager 116. Operation metrics are updated for any policy that is index by the user. The operation metrics may be staged in the analysis storage 114. For example, for a policy that is to identify a threat when a user has performed N-number of successive deletes, block 608 includes incrementing a counter for delete operations for the user.

At block 608, the event analyzer 112 determines whether the operation matches any policy in the database for the user. If the operation does not match (“NO” at block 610), the method proceeds to end at block 614. If the operation matches a policy (“YES” at block 610), control passes to block 612 where the event analyzer 112 processes the policy by determining if the conditions have been met, and if the policy's conditions are violated, an alert is sent. For example, the alert may be the control signal sent to the compliance enforcer 120 and/or an error message sent back to the user client. After block 612, the method 600 ends at block 614

In the foregoing description, numerous details are set forth to provide an understanding of the subject matter disclosed herein. However, implementation may be practiced without some or all of these details. Other implementations may include modifications and variations from the details discussed above. It is intended that the following claims cover such modifications and variations.

What is claimed:

1. A system comprising:
a file system that manages data placed on a storage medium and that services input/output (I/O) events from file protocol clients;
a file access audit system to produce an audit log of the I/O events from the file system;
an event analyzer to analyze the audit log based on compliance policies to generate a control signal;
a compliance enforcer integrated in an I/O path of the file system to receive the control signal from the event analyzer and to cause the file system to execute a file system lock down in response to the control signal indicating that at least one policy of the compliance policies has been violated by at least one of the I/O events in the audit log.

2. The system of claim 1, wherein the compliance enforcer is to cause the file system to execute the file system lock down by instructing the file system to fail I/O events for a specific file share associated with the at least one of the I/O events.

3. The system of claim 1, wherein the file system is among a plurality of file systems on a file server,
the file access audit system is to produce the audit log by serializing I/O events from all file systems of the plurality of file systems, and
the compliance enforcer is to cause the file system to execute the file system lock down for a particular file system of the plurality of file systems that is associated with an I/O event in the audit log identified via the event analyzer as violating a compliance policy of the compliance policies.

4. The system of claim 1, wherein the audit log includes a mix of I/O events associated with different file protocols.

5. The system of claim 1, wherein the compliance enforcer is a user-kernel mode bridge between the file access audit system that is user mode and the file system that is kernel mode.

6. The system of claim 1, wherein the compliance polices are on a per-user basis, and
the event analyzer analyzes the audit log by breaking down each of the I/O events of the audit log into a user and an operation, and assessing whether the user and the operation violate any of the compliance policies.

7. The system of claim 1, further comprising a compliance manager in communication with the file system that presents a two-person authorization security control to re-enable a file share disabled by the file system lock down.

8. The system of claim 1, wherein the compliance policies are in a simple descriptive language.

9. The system of claim 1, wherein the event analyzer is to analyze the audit log and the compliance enforcer is to cause the file system to execute a file system lock down in real-time as I/O events are received at the file system from the file protocol clients.

10. Non-transitory machine readable medium storing instructions executable by a processing resource, the non-transitory machine readable medium comprising:
instructions to receive, from different file protocol clients, input/output (I/O) events directed to a file system that manages data placed on a storage medium;
instructions to produce an audit log of I/O events received from the different file protocol clients;
instructions to analyze the audit log based on compliance policies to generate a control signal; and
instructions to send a file system lock down command directly to the file system via an I/O path of the file system in response to the control signal indicating that at least one policy of the compliance policies has been violated by at least one of the I/O events in the audit log.

11. The non-transitory machine readable medium of claim 10, wherein the file system lock down command includes instructions that cause the file system to fail I/O events for a specific file share associated with the control signal.

12. The non-transitory machine readable medium of claim 10, wherein the file system is among a plurality of file systems on a file server,
the instructions to produce the audit log serializes all I/O events directed to the plurality of file systems, and
the instructions to send the file system lock down command is to send the file system lock down command to a particular file system of the plurality of file systems that is associated with an I/O event in the audit log identified via the event analyzer as violating a compliance policy of the compliance policies.

13. The non-transitory machine readable medium of claim 10, wherein the compliance polices are on a per-user basis, and
the instructions to analyze the audit log includes instructions to break down each of the I/O events of the audit log into a user and an operation and instructions to assess whether the user and the operation violate any of the compliance policies.

14. The non-transitory machine readable medium of claim 10, further comprising instructions to present a two-person authorization security control to re-enable a file share disabled by the file system lock down.

15. The non-transitory machine readable medium of claim 10, further comprising instructions to communicate, to other file systems in a data center, a file system lock down message based on the control signal.

16. A method comprising:
receiving, by a file system and from different file protocol clients, input/output (I/O) events related to data placed on a storage medium and managed by the file system;
producing, by a file access audit system, an audit log of I/O events received from the different file protocol clients;
analyzing, by an event analyzer, the audit log based on compliance policies to generate a control signal; and
sending, by a compliance enforcer integrated in an I/O path of the file system, a file system lock down command directly to the file system in response to the control signal received from the event analyzer indicating that at least one policy of the compliance policies has been violated by at least one of the I/O events in the audit log.

17. The method of claim 16, wherein the file system is among a plurality of file systems on a file server,
the producing the audit log includes serializing all I/O events directed to the plurality of file systems, and
the sending the file system lock down command includes sending the file system lock down command to a particular file system of the plurality of file systems that is associated with an I/O event in the audit log identified via the event analyzer in the analyzing as violating a compliance policy of the compliance policies.

18. The method of claim 16, wherein the compliance polices are on a per-user basis, and
the analyzing includes breaking down each of the I/O events of the audit log into a user and an operation and assessing whether the user and the operation violate any of the compliance policies.

19. The method of claim 16, further comprising presenting, by a compliance manager in communication with the file system, a two-person authorization security control to re-enable a file share disabled by the file system lock down.

20. The method of claim 16, wherein the file system lock down command is to cause the file system to fail I/O events for a specific file share associated with the control signal.
